(19) United States
(12) Patent Application Publication
(10) Pub. No.: US 2019/0088380 A1
(43) Pub. Date: Mar. 21, 2019

(54) Nuclear Photovoltaic Electricity Producer

(71) Applicant: Robert Van Nail, Warren, MI (US)

(72) Inventor: Robert Van Nail, Warren, MI (US)

(21) Appl. No.: 15/732,101

(22) Filed: Sep. 19, 2017

(51) Int. Cl. G21H 1/12

(52) U.S. Cl. CPC G21H 1/12; G21Y 2002/20

(57) ABSTRACT

Continuous electricity from Uranium without heat or moving parts

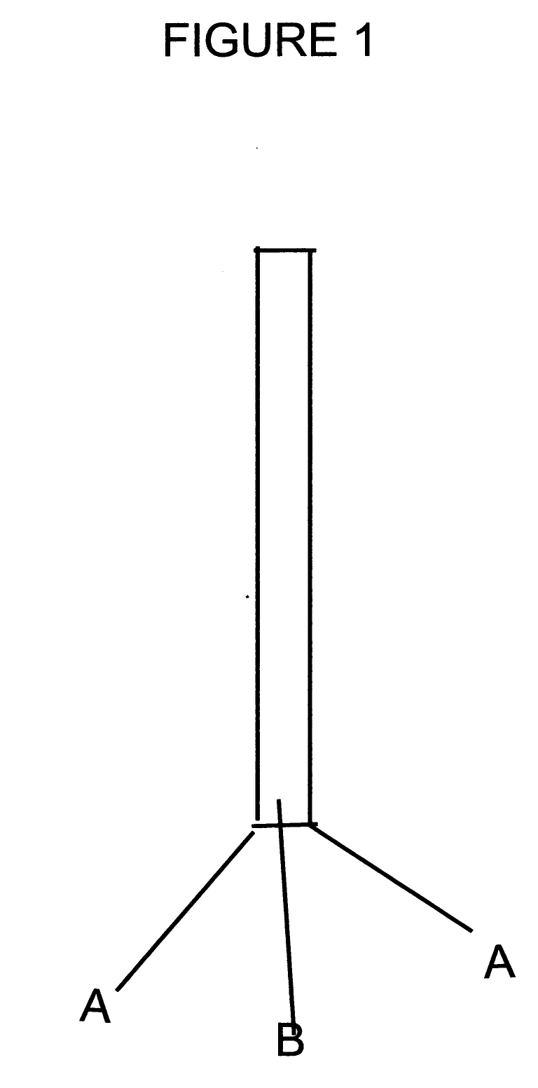

### FIELD OF THE INVENTION

The present invention relates to production of electricity and, more particularly, to convert low energy Uranium and rare earth phosphor luminescencent crystals into light which will be converted into electricity with photovoltaic cells without heat or moving parts.

### BACKGROUND OF THE INVENTION

Creating electricity from nuclear materials without heat or moving parts.

Current nuclear plants create electricity by generating steam in order to turn turbines that produce the electricity.

The short comings of current nuclear technology require heat and moving parts in order to generate electricity.

### SUMMARY OF THE INVENTION

In accordance with the present invention, there is provided . . . continuous electricity from Uranium without heat or moving parts.

It would be advantageous to provide a safe, portable electrical generator, which is cost effective.

It would be advantageous to provide an extremely long life, with continuous power output.

It would further be advantageous to provide a small power source that can be formed into varying shapes. All components are malleable.

It would be safer and cheaper to build very large units tied into current infra-structure of power plants.

Generating electricity without heat or moving parts.

### DESCRIPTION OF THE PREFERRED EMBODIMENT

FIGURE one is a cross section of photovoltaic cells and rare earth phosphorluminecence crystals mixed with uranium.

The photovoltaic cells are facing inward in order to receive the light.

### BRIEF DESCRIPTION OF THE DRAWING

A complete understanding of the present invention may be obtained by reference to the accompanying drawing, when considered in conjunction with the subsequent, detailed description, in which:

FIGURE one is a section view of one cell of the Nuclear photovoltaic electricity producer. A is a photovoltaic facing inward. B is a layer of phospherluminsces and uranium mixture.

For purposes of clarity and brevity, like elements and components will bear the same designation and numbering throughout the FIGURE

What is claimed is:

1. A nuclear photovoltaic electricity producer for producing electricity from radioactive materials without heat or moving parts. comprising:
means for generating electricity: and
means for creating light for the photovoltaic cell, rigidly connected to said means for generating electricity.

2. The nuclear photovoltaic electricity producer in accordance with claim 1, where in said means for generates electricity comprises a commonly found, new attribute 2 photovoltaic cells.

3. The nuclear photovoltaic electricity producer in accordance with claim 1, where in said means to creating light for the photovoltaic cells comprises o light source with out heat with phosphor luminent crystals and Uranium mixture.

5. A nuclear photovoltaic electricity producer for producing electricity from radioactive materials without heat or moving parts, comprising:
a commonly found, new a 2 photovoltaic cells, for generating electricity: and
a light source without heat for phosphor luminescent crystals and Uranium mixture, to create light for photovoltaic cells, rigidly connected to said photovoltaic cells.
